(19) United States
(12) Patent Application Publication
(10) Pub. No.: US 2026/0309301 A1
(43) Pub. Date: Oct. 8, 2026

(54) A SKIN STRUCTURE AND A FORMING METHOD THEREOF

(71) Applicant: Yanfeng International Automotive Technology Co. Ltd., Novi, MI (US)

(72) Inventors: Cheng WU, Shanghai (CN); Ding XIE, Shanghai (CN); Jie SUN, Shanghai (CN); Xiaoqin DING, Shanghai (CN); Liyong WANG, Shanghai (CN)

(21) Appl. No.: 19/481,555

(22) PCT Filed: May 7, 2024
(86) PCT No.: PCT/CN2024/091344

§ 371 Date: Nov. 5, 2025

(30) Foreign Application Priority Data
May 9, 2023 (CN) 202321117046.2

(51) Int. Cl. F21V 1/00; B60Q 3/10; B60Q 3/54; B60Q 3/62; B60R 13/02; F21V 8/00; F21V 9/32; F21W 106/00

(52) U.S. Cl. CPC F21V 1/00; B60Q 3/54; B60Q 3/62; B60R 13/02; F21V 9/32; G02B 6/001; B60Q 3/10; F21W 2106/00

(57) ABSTRACT

A skin structure (A) and a forming method therefor. The skin structure (A) comprises a framework (1), a skin (2) and a trim strip (3, 30, 300) having a light-emitting or light-transmitting function, wherein the skin (2) covers the framework (1) and is provided with a groove (21), at least part of the trim strip (3, 30, 300) fills the groove (21), and the skin structure (A) is formed by performing three-color injection molding on the framework (1), the skin (2) and the trim strip (3, 30, 300).

### TECHNICAL FIELD

The present disclosure relates to vehicle interior trim, and more particularly to a skin structure and method of forming the same.

### BACKGROUND TECHNOLOGY

The instrument panel assembly is similar to a fan window, which reflects the operation state of the machine internal machine at any time. It is also a part of the control center of the device and the decorated object, which is the most compelling component in the cab. The instrument panel assembly has both the functions of the technology and the artistic function, which is a representative of the style of the whole vehicle, and the splicing line embedding bar on the soft part in the seat cabin can play a relatively good decorative effect, which is easy to become the “bright spot” of the drawing in the interior trim, and therefore, it is used by more and more hosts.

In the existing embedding structure, the skin needs to be adhered to the injection molding skeleton by glue, and manual sewing and coating are performed on the skin, so that the labor cost is compared, and there is a sewing seam exposed mark (that is, there is a splicing seam) at the end, which affects the aesthetic appearance. In addition, if the end of the embedded strip forms a full skin-free seam design, wrinkles appearing on the skin are difficult to process and become a technical problem.

At present, a decorative effect is formed without a light-emitting function in addition to a decorative effect.

### DISCLOSURE

The present disclosure provides a skin structure and a forming method thereof, in order to solve the problems caused by manual sewing of embedding strips in the prior art.

A first aspect of the present disclosure provides a skin structure, comprising a skeleton, a skin, and a strip having a light-emitting or light-transmitting function, wherein the skin covers above the skeleton and is provided with a groove, the embedding strip is at least partially filled in the groove, and the skin structure is formed by performing three-color injection molding on the skeleton, the skin and the embedding strip.

Preferably, the embedding strip is a strip with a light transmittance of 0.1% to 20%.

Preferably, the material of at least one of the skin and the embedded strip is TPE. In a preferred embodiment, the embedding bar is a TPE bar.

Preferably, the skin structure further comprises an injection-molded suture having a light-emitting function.

Preferably, the skin structure further comprises a lamp group module arranged below the embedded strip to realize the light-emitting function of the embedded strip.

Preferably, the lamp group module includes a mounting frame fixed to the frame, an inner bottom wall of the mounting frame is provided with a positioning groove, and an interior of the positioning groove is provided with a light source.

Preferably, the inner top of the mounting frame is provided with a light-transmitting plate, and light emitted by the light source illuminates the embedding strip through the light-transmitting plate.

Preferably, the top surface of the skin provides at least two different skins.

Preferably, the embedded strip is a self-luminous strip.

Preferably, the embedded strip is made of a light-transmitting TPE material mixed with a rare-earth light-storing light-emitting material, or made of plastic capable of emitting fluorescent or glow.

Preferably, the embedded strip is an energized light-emitting block.

Preferably, the skin structure further comprises a light guiding optical fiber inserted in the embedding bar and a light emitting source providing a light source to the light guiding optical fiber.

Preferably, the skin is further provided with an opening for filling the skeleton.

Preferably, the skeleton is made of a light-transmitting or semi-light-transmitting material and the inlay is made of a light-transmitting or semi-light-transmitting material different from the skeleton color.

Preferably, the skin is made of an opaque or semi-transparent TPE material.

A second aspect of the present disclosure provides a molding method for a skin structure, the skin structure comprising a frame, a skin, and a strip having a light-emitting or light-transmitting function. The forming method sequentially comprises: an injection-molded skeleton; an injection-molded skin, such that the skin covers above the skeleton, wherein the skin is provided with a groove; and an injection-molded strip, such that the embedded strip is at least partially filled in the groove.

According to a third aspect of the present disclosure, there is provided a method for forming a skin structure, the skin structure including a frame, a skin, and a strip having a light-emitting or light-transmitting function, the forming method sequentially comprising: an injection-molded skeleton; an injection-molded strip on the skeleton; and an injection-molded skin, such that the skin covers above the skeleton, wherein the skin is provided with a groove, and the embedded strip is at least partially filled in the groove.

According to the skin structure of the present disclosure, the required soft goods are integrally formed by means of three-color injection molding, other operations such as sewing and glue bonding are not required, and the embedding strip can provide a light-emitting function, and two ends of the embedding strip can form a decorative effect in the form of a seamless seam, that is, there is no splicing seam and no wrinkles.

### BRIEF DESCRIPTION OF THE DRAWINGS

FIG. 1 shows a vehicle equipped with a skin structure according to the present disclosure.

FIG. 2 illustrates an interior of a vehicle.

FIG. 3 is a top view of a skin structure according to a first embodiment of the present disclosure.

FIG. 4 is a cross-sectional view of FIG. 3.

FIG. 5 is a partial enlarged view of FIG. 3.

FIG. 6 is a cross-sectional view of a skin structure according to a second embodiment of the present disclosure.

FIG. 7 is a cross-sectional view of a skin structure according to a third embodiment of the present disclosure.

FIG. 8 is a partially enlarged view of FIG. 7.

FIG. 9 is a top view of a skin structure according to a fourth embodiment of the present disclosure.

FIG. 10 is a cross-sectional view taken along plane B-B in FIG. 9.

FIG. 11 is a partial enlarged view of FIG. 10.

### DETAILED DESCRIPTION OF THE EMBODIMENTS

Preferred embodiments of the present disclosure are given below with reference to the accompanying drawings, and are described in detail.

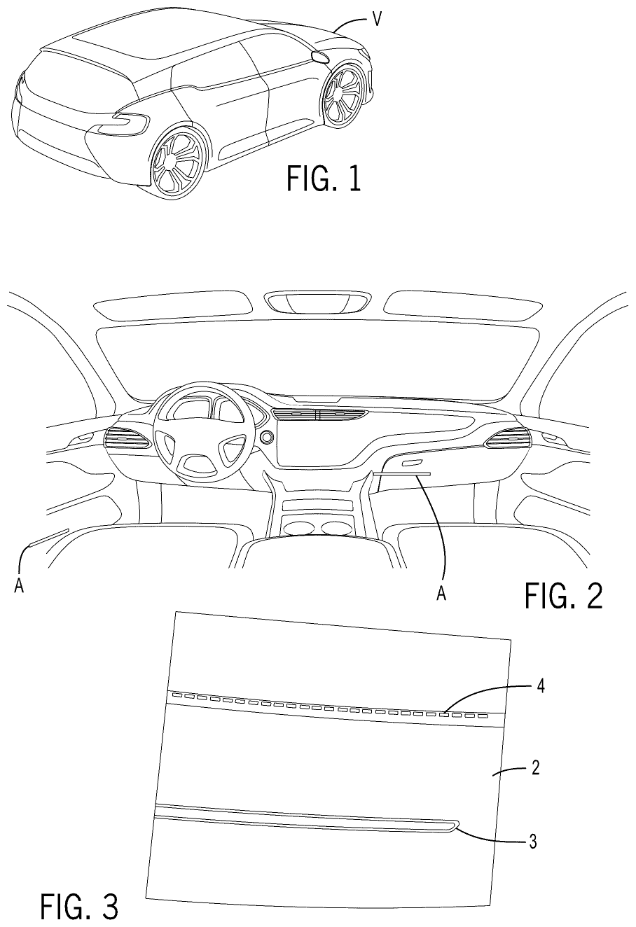

As shown in FIGS. 1-2, the skin structure A according to the present disclosure is mounted inside the vehicle V. It should be understood that the position and form of the skin structure A shown in FIG. 2 are by way of example only and not limitation.

### First Embodiment

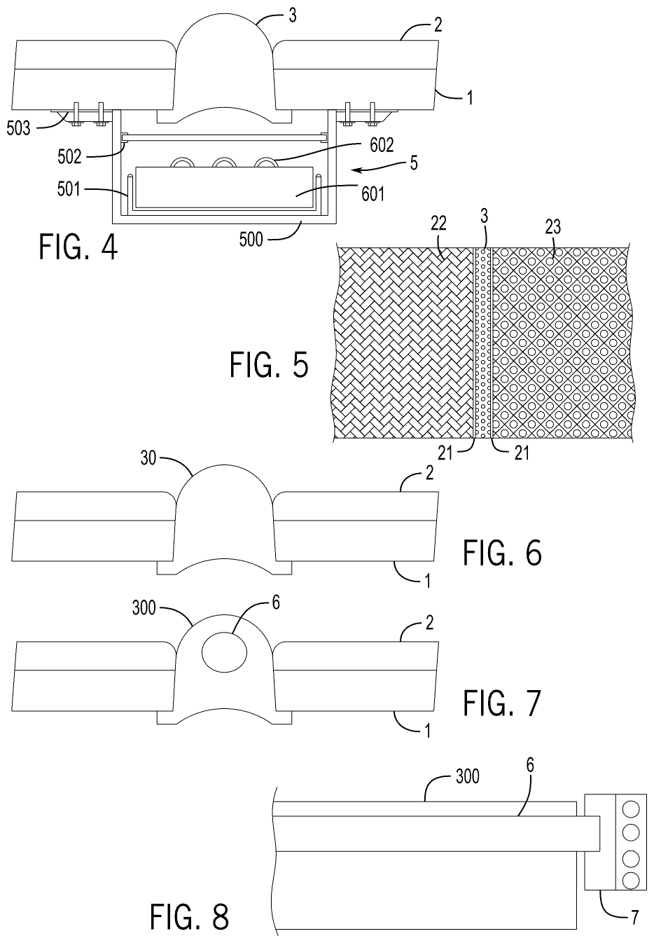

As shown in FIG. 3 to FIG. 4, the skin structure according to the first embodiment of the present disclosure includes a frame 1, a skin 2, and a strip 3 with a light emitting function/light transmission, wherein the skin 2 covers the frame 1, a groove 21 is formed in the middle of the skin 2 (see FIG. 5), and at least part of the embedding strip 3 is at least partially filled in the groove 21.

The skin structure is formed by performing three-color injection molding on the skeleton 1, the skin 2 and the embedding bar 3. Compared with the conventional manner, the skin 2 of the present disclosure is no longer bonded to the skeleton 1 by glue, and the sewing of the embedded strip 3 on the skin 1 is omitted. More specifically, one molding method of the skin structure may be preferentially injecting the skeleton 1, and then curing the skin 2 on the skeleton 1 by injection molding, so that the skin 2 covers the skeleton 1, and then embedding the embedding strip 3 in the groove 21 of the skin 2 by means of a micro-injection molding process, so that the embedding strip 3 is at least partially filled in the groove 21, so that the required soft product is integrally formed by means of three-color injection molding, and other operations such as sewing and glue bonding are not required. Compared with the conventional manner, the embedded strip 3 of the skin structure of the present disclosure may provide a light-emitting function, and both ends of the embedded strip 3 May form a decorative effect in the form of a seam-free form, that is, there is no splicing seam and no wrinkles.

According to a variant of the molding method of the skin structure, the skeleton 1 May be preferentially injected, and then the insert 3 is injection-molded on the skeleton 1, and then the skin 2 is injection-molded on the skeleton 1, so that the skin 2 covers the skeleton 1, and the embedding strip 3 is at least partially filled in the groove 21 of the skin 2.

In this embodiment, the skeleton 1 is made of a PC material. It should be understood that the skeleton 1 may also be made of a material such as PC/ABS, PP/PE, ABS or PA6.

In this embodiment, the skin 2 is made of a TPE material. It should be understood that the skin 2 may also be made of materials such as PP/PE, ABS or PA6.

In this embodiment, the embedding strip 3 is made of a light-transmitting TPE material, and has a light-transmitting function, and the light transmittance is between 0.1% and 20%, so as to provide a soft light-transmitting embedded decorative effect. In particular, the embedded strip 3 is arranged as a TPE material, and has dual characteristics of plastic and rubber, so that the embedded strip may be directly injection molded into the groove 21 of the skin 2, and other operations such as hot pressing and glue bonding are not required, so that the process steps and the cost saving are not required, wrinkles of the tail end on the skin can be avoided while the tail end is free of the splicing structure, and in addition, the light transmittance of the embedded strips of the TPE and the light strip can also be achieved while forming the article, so that a certain decorative effect is achieved, and the use esthetics of the instrument panel are ensured.

As shown in FIG. 3, the skin structure according to the present embodiment further includes an injection-molded suture 4, which is the same as the forming process and the light-emitting function of the embedded strip 3, and is only contoured to be the shape of the sewing thread, so as to meet the corresponding requirements.

As shown in FIG. 4, the skin structure according to this embodiment further includes a lamp group module 5 arranged below the embedded strip 3 to realize the light-emitting function of the embedded strip 3. Specifically, the lamp group module 5 comprises a mounting frame 500, which is connected to the frame 1 by means of a mounting bolt 503, the inner bottom wall of the mounting frame 500 is provided with a positioning groove 501, and the interior of the positioning groove 501 is provided with a light source. The light source may be in the form of a light strip 601, two ends of the light strip 601 respectively extend towards the front and rear ends of the mounting frame 500, a plurality of groups of lamp beads 602 are equidistantly provided on the top surface of the light strip 601, a light-transmitting plate 502 is mounted at the inner top of the mounting frame 500, and light emitted by the lamp beads 602 illuminates the embedded strip 3 through the light-transmitting plate. 502 to achieve a light-transmitting function. In addition, by controlling the control program of the plurality of groups of lamp beads 602, the light strip 601 can be controlled to maintain a normally bright, bright and dark change or color change in a set manner, so that the overall static, overall dynamic, or local dynamic light effect can be formed. It should be understood that the light source may alternatively be in other arrangements, and the light-transmitting plate 502 forms light with uniform light intensity to illuminate the embedded strip 3 to achieve a light-transmitting function.

As shown in FIG. 5, the top surface of the skin 2 may provide two different skins 22, 23 on opposite sides of the embedded strip 3, and in the present embodiment, the mold for forming the skin 2 is subjected to laser treatment, one side of the groove 21 forms a skin texture, and the other side of the groove 21 forms a fabric texture. It should be understood that the texture and position of the texture herein are by way of example only and not limitation, and any other special texture (such as a geometric pattern) may be provided at different parts as required.

### Second Embodiment

As shown in FIG. 6, the embedded strip 30 of the skin structure according to the second embodiment of the present disclosure is a self-luminous strip. In this embodiment, the strip 30 is made of a light-transmitting TPE material mixed with a rare-earth light-storing light-emitting material (light-emitting powder). It will be appreciated that the insert 30 may also be a plastic (e.g. PC) capable of emitting fluorescent or glow. After the sunlight irradiates the light, the light energy is converted and stored, and then a pigment with lower frequency light is emitted in the dark, so that the plastic presents glow.

### Third Embodiment

As shown in FIG. 7, the embedded strip 300 of the skin structure according to the third embodiment of the present disclosure is an energized light-emitting block. In this embodiment, the bar 300 is made of TPE material. It should be understood that the bar 300 may also be provided by a PC. The skin structure of the present embodiment further comprises a light guide fiber 6 inserted in the insert 300 and a light source 7 providing a light source to the light guide fiber 6.

### Fourth Embodiment

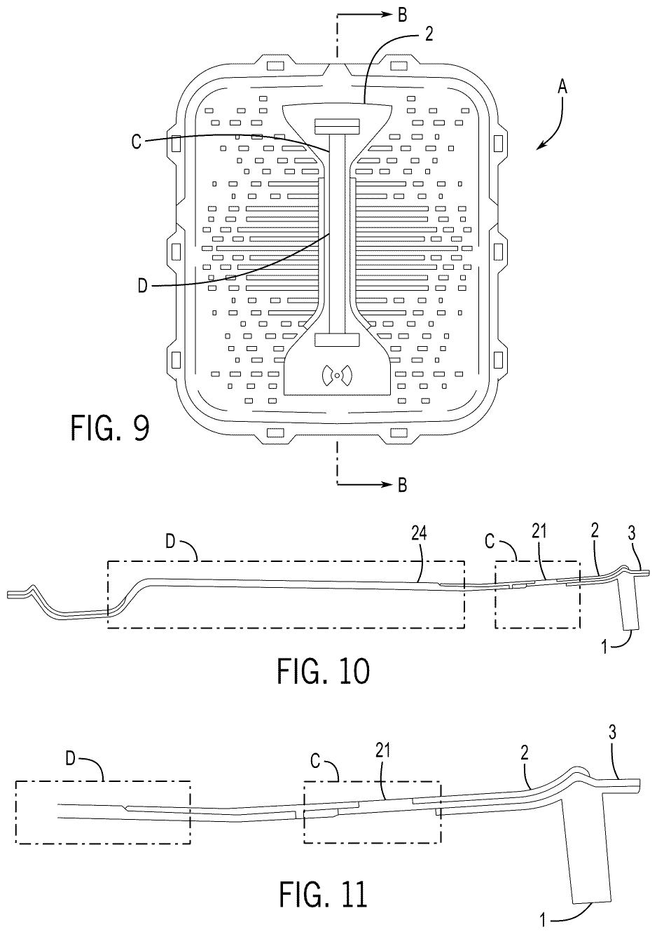

As shown in FIG. 9 to FIG. 11, the difference between this embodiment and the first embodiment lies in that the embedding strip 3 is sandwiched between the frame 1 and the skin 2, and a part of the protrusion on the embedding strip 3 is filled in the groove 21 of the skin 2. In addition, the skin 2 is further provided with an opening 24 for the filling skeleton to be made of a light-transmitting or semi-light-transmitting material, the embedding strip 3 is made of a light-transmitting or semi-light-transmitting material different from the color of the skeleton 1, and the skin 2 is made of an opaque TPE material, for example.

According to a molding method of the skin structure, the skeleton 1 may be preferentially injected, and then the embedded strip 3 is injection-molded on a part of the skeleton 1, and then the skin 2 is injection-molded on the skeleton 1, so that the skin 2 covers the skeleton 1 and enables the insertion strip 3 to be clamped between the skeleton 1 and the skin 2, so that a part of the protrusion on the embedding strip 3 can be filled in the groove 21 of the skin 2, and a part of the protrusion on the skeleton 1 can be filled in the opening 24 of the skin 2.

The light source may be, for example, disposed below the skeleton 1, that is, disposed on a side of the skeleton 1 facing away from the embedding bar 3. After the light emitted by the light source passes through the frame 1 and the embedding strip 3 respectively, different colors can be seen in the area C (i.e. the area of the groove 21 of the skin 2) and the area D (i.e. the area of the opening 24 of the skin 2) shown in FIG. 10 and FIG. 11. It can be understood that according to one implementation variant, the skin 13 is also made of a semi-transparent TPE material, so as to form more light-transmitting color combinations.

The above are only preferred embodiments of the present disclosure and are not intended to limit the scope of the present disclosure, and various changes may also be made in the above embodiments of the present disclosure. That is, any simple, equivalent change and modification made according to the claims of the present disclosure and the description of the specification all fall within the protection scope of the claims of the present disclosure. The present disclosure is not described in detail as conventional technical content.

1. A skin structure wherein the skin structure comprises a frame a skin and a strip having a light-emitting or light-transmitting function wherein the skin covers the frame and is provided with a groove the embedding strip is at least partially filled in the groove and the skin structure is formed by performing three-color injection molding on the frame the skin and the embedding strip.

2. The skin structure of claim 1 wherein the embedded strip is a strip with a light transmittance of 0.1% to 20%.

3. The skin structure of claim 1 wherein a material of at least one of the skin and the embedded strip is TPE.

4. The skin structure of claim 1 wherein the skin structure further comprises an injection-molded suture having a light-emitting function.

5. The skin structure of claim 1 wherein the skin structure further comprises a lamp group module arranged below the embedded strip to realize the light-emitting function of the embedded strip.

6. The skin structure of claim 5 wherein the lamp group module comprises a mounting frame fixedly connected to the framework a positioning groove is provided on an inner bottom wall of the mounting frame and a light source is provided inside the positioning groove.

7. The skin structure of claim 6 wherein a light-transmitting plate is mounted at an inner top of the mounting frame and light emitted by the light source illuminates the embedding strip through the light-transmitting plate.

8. The skin structure of claim 1 wherein the top surface of the skin provides at least two different skins.

9. The skin structure of claim 1 wherein the embedded strip is a self-luminous strip.

10. The skin structure of claim 9 wherein the embedded strip is made of a light-transmitting TPE material mixed with a rare-earth light-storing light-emitting material or is made of plastic capable of emitting fluorescent or glow.

11. The skin structure of claim 1 wherein the embedded strip is an energized light-emitting block.

12. The skin structure of claim 10 wherein the skin structure further comprises a light guide optical fiber inserted in the embedded strip and a light emitting source for providing a light source to the light guide optical fiber.

13. The skin structure of claim 1 wherein the skin is further provided with an opening for filling the skeleton.

14. The skin structure of claim 13 wherein the skeleton is made of a light-transmitting or semi-light-transmitting material and the embedding bar is made of a light-transmitting or semi-light-transmitting material different from the skeleton color.

15. The skin structure of claim 14 wherein the skin is made of an opaque or semi-transparent TPE material.

16. A method for forming a skin structure the skin structure comprising a frame, a skin and a strip having a light-emitting or light-transmitting function wherein the forming method sequentially comprises:
an injection molding framework;
injection molding the skin such that the skin covers over the skeleton wherein the skin is provided with a groove; and
The insert is injection molded such that the insert is at least partially filled in the groove.

17. A method for forming a skin structure the skin structure comprising a frame a skin and a strip having a light-emitting or light-transmitting function wherein the forming method sequentially comprises:
an injection molding framework;
injection molding a strip on the skeleton; and
an injection molding skin such that the skin covers above the skeleton wherein the skin is provided with a groove and the embedding strip is at least partially filled in the groove.
